(19) United States
(12) Patent Application Publication
(10) Pub. No.: US 2009/0251612 A1
(43) Pub. Date: Oct. 8, 2009

(54) MOTION VECTOR FIELD RETIMER

(75) Inventor: Jacobus Willem Van Gurp, Eindhoven (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/090,736

(22) PCT Filed: Oct. 20, 2006
(86) PCT No.: PCT/IB2006/053877

§ 371 Date: Feb. 5, 2009

Related U.S. Application Data
(60) Provisional application No. 60/730,162, filed on Oct. 24, 2005.

(51) Int. Cl. H04N 5/00

(52) U.S. Cl. 348/614; 348/E05.001

(57) ABSTRACT

A programmable platform is provided that implements a video-processing algorithm that reduces halo artifacts. The algorithm corrects motion vectors of background motion in occlusion areas of a picture. The algorithm creates a re-timing vector from vector fields provided from a 3-frame motion estimator. The re-timing vector is produced by, first, selecting a number of candidate pairs of vectors from the different vector fields provided from the 3-frame motion estimator. Then, second, choosing one pair of candidate vectors based on an error metric. And, third, applying a linear or non-linear interpolation to obtain the required vector field. The re-timing vector provides a vector field for pixels between pictures n and n-\ such that halo about moving objects are minimized.

The present invention relates to motion compensated frame rate conversion techniques for video material. More specifically, embodiments of the present invention relate to using interpolation techniques an algorithm that reduces ‘halo’ artifacts about a moving video image.

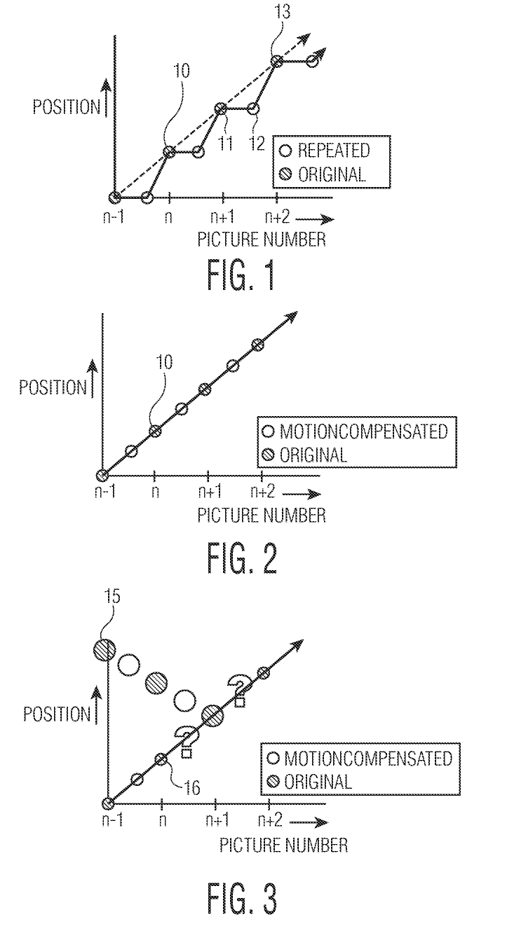

Modem television sets have to display video material from diverse sources that may differ in original picture rate. Different parts of the world are using different standards. For example, in Europe 50 images/sec are displayed and in other parts of the world, like the United States, 60 images/sec are displayed. Not all of the visible material is recorded with a video camera. A movie, for instance, is recorded at 24 progressive frames/sec. The easiest way to display such a movie on a 60(50) Hz television is to repeat the images. In the United States, every image of the movie is displayed either 3 or 2 times to get 60 images/sec; this is called 3:2 pull down. In Europe, every image is displayed twice; this is called 2:2 pull down. A 24 Hz movie is played at a slightly faster rate to get 50 images/sec. Unfortunately, these simple solutions result in degradation of image quality. Since the images are repeating, the image repetition of pictured moving objects will alternate as moving and standing still. A result of the image repetition is that the viewer will observe an irregular or jerky object in motion. This artifact is often called ‘motion judder’ or ‘film judder’. FIG. 1 shows an example of a moving ball 10. The movement of the ball was recorded at 25 Hz, but because 50 images/sec have to be displayed every image is shown twice. Thus, the resulting pictures display the ball in the same place for two frames 11,12, then the ball moves for one frame 13, then stays still, etc.

To solve the problem of motion judder and to make the movements of objects smoother, an interpolated image is calculated and used instead of using the repeated image. This interpolated image requires every object or pixel in the image to be moved according to its own motion. This is called motion compensated temporal up-conversion. For the moving ball example it means that for the interpolated images, the ball 10 is placed on the line of the motion portrayal as shown in FIG. 2. One problem with interpolated images is that a so-called ‘halo’ artifact can be created about the moving object if the interpolated images are not calculated correctly. A halo artifact is a visible smear around moving objects.

Currently there are a few solutions for coping with problem of the halo artifact. When an object appears from behind another object, or if an object is disappearing behind another object, the object (or part of the object) is only available in one of the two images. As a result of this, an estimator cannot find a proper match, so the vector for the pixel movement is unreliable. Also if the vector is correct, the interpolated pixel can be wrong because one of the pixels may already be wrong. A result from these problems is that most of the time parts of the background that are close to a moving object are moving with the foreground velocity. This results and looks like a ‘halo’ around the object.

In most cases a foreground vector (the vector of a pixel in a foreground moving object) will overlap the foreground object. This occurs because the background vector points on one side into the foreground object and on the other side into the background while the foreground vector points in both images into the background. Although the vector points to two different parts of the background, it will give a better match than the background vector. (Two different parts of background are often more alike than a part of background and part of foreground.)

FIG. 3 shows the occlusion problem in the moving ball example. Another ball, a big ball 15, is moving with a different velocity and in a different direction than the small ball 16. In picture n+1, the small ball 16 disappears behind the big ball 15. When the small ball 16 is behind the big ball 15 the motion estimator cannot find the movement of the small ball 16 from picture number n to n+1. And therefore it is not clear where the small ball 16 has to be positioned in the interpolated picture (n+1/2).

To solve the halo problem, a first algorithm was developed at Philips Research. This algorithm, known at Philips Research under the name puma/cobra algorithm. The puma/cobra algorithm consists of two parts, the motion estimator (PUMA) and the temporal up-converter (COBRA). Because this background discussion is about mapping the temporal unconverter on a programmable platform for the implementation of video processing algorithms, the motion estimator will only be briefly described. The main focus will be on the temporal up-converter.

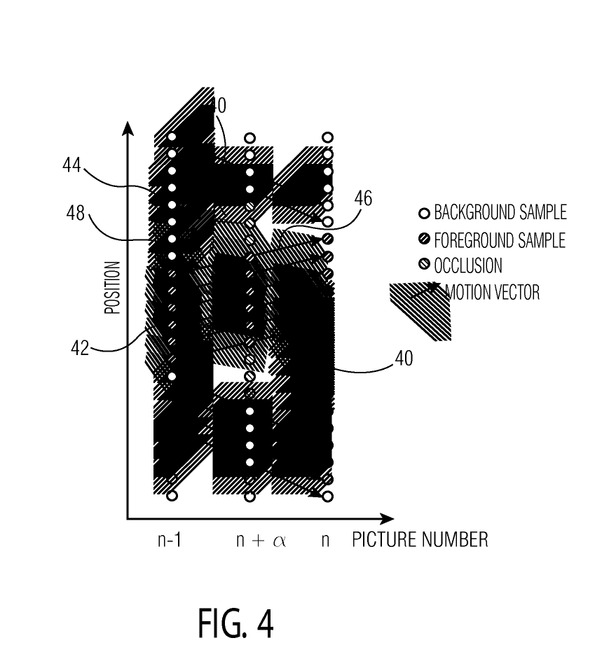

A motion estimator may be based on a 3D recursive search block-matching algorithm. In the past, motion estimation was done at the temporal position. That is, for every block of the to be interpolated picture a motion vector was assigned. This method had problems in occlusion areas because in occlusion areas the image information was only available in one of the two pictures. FIG. 4 shows that at an interpolation position (n+α) for the foreground and the background, a correct motion vector can be found. But, in the occlusion area 40 a correct motion vector cannot be found because part of the background 44 disappeared behind the foreground 42 object. In occlusion areas, a probability of getting a foreground vector is higher because the foreground vector 46 matches part of the background with another part of the background whereas the background vector 48 matches part of the background with part of the foreground.

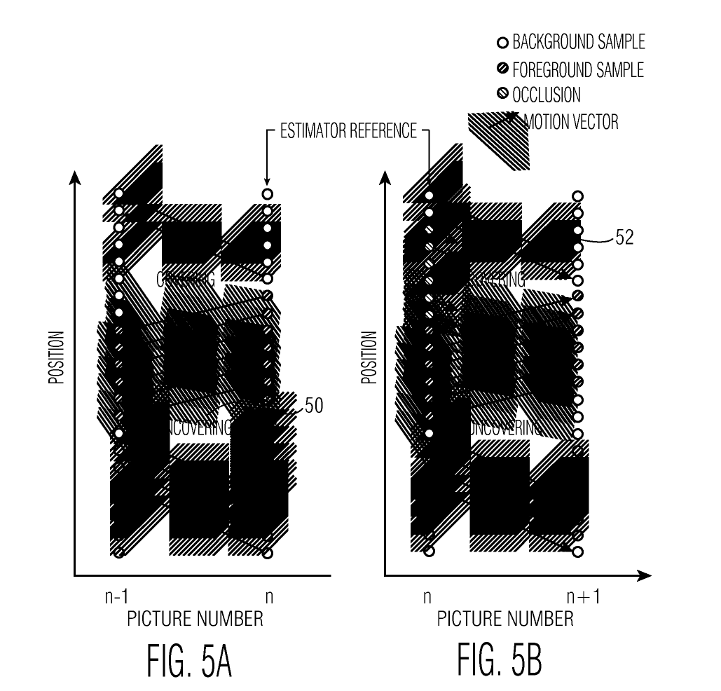

When motion estimation is performed in a backwards manner from a current position, there is no problem with covering because for all the blocks in the current frame there is a matching block in the previous frame that can be found (See FIG. 5A). But uncovering becomes a problem for the uncovered area 50 in FIG. 5A because a good match in the previous picture can be found. On the other hand, when the motion estimation is done in a forward manner from the current position of a moving pixel there is no problem with uncovering, but instead there is a problem with covering 52(See FIG. 5B)

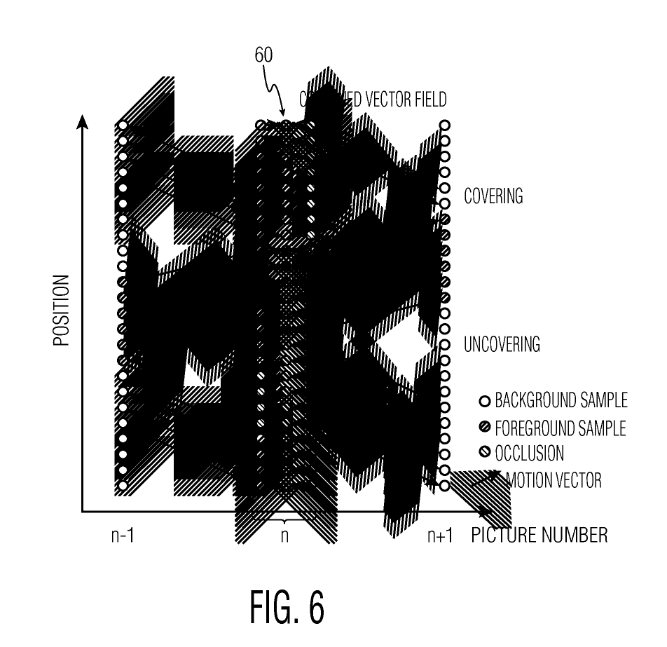

The Puma motion estimator performs both forward estimation and backward estimation and then combines the two vector fields into an occlusion free vector field 60 at the position of the current original picture (see FIG. 6). The motion estimator assigns vectors to every block of 8×8 pixels. The Cobra up-converter then uses the current 60a and the previous vector fields 60b to retime the vector field 60 to the interpolation position. Besides the two occlusion free vector fields, the up-converter also utilizes the previous forward estimation and the current backwards estimation.

Before moving forward there are some definitions used in the equations that follow that need to be provided:
\vec{D}₃(x,n) is a current combined motion vector (or 3 frame motion estimation) at position \vec{x}.
\vec{D}_{f}(\vec{x},n) is a current forward motion vector at position \vec{x}.
\vec{D}_{b}(\vec{x},n) is a current backward motion vector at position \vec{x}.

In a Cobra up-converter there are three distinguishable stages. In a first stage, a first set of masks and vector fields are prepared. The re-timer calculates an accurate vector field for the temporal position. The vector field calculated by the re-timer is an average of the previous forward and current backward estimations; this is called the fall-back vector field (see Equation 2.1).

\vec{D}_{avg}(\vec{B},n+α)=Average(\vec{D}_{f}(\vec{B},n−1),\vec{D}_{b}(\vec{B},n)) (2.1)

An occlusion mask shows where in the image covering and uncovering occurs. A consistency mask selects the areas where the vector field is inconsistent. And a text mask selects the static regions in the image, mainly to protect subtitles and other text-like overlays.

The second and main stage is the pixel processing stage. Here the vector fields and the masks are used to select the right pixels and calculate the output pixels. At the third and last stage, the ‘difficult’ areas are blurred to hide possible artifacts.

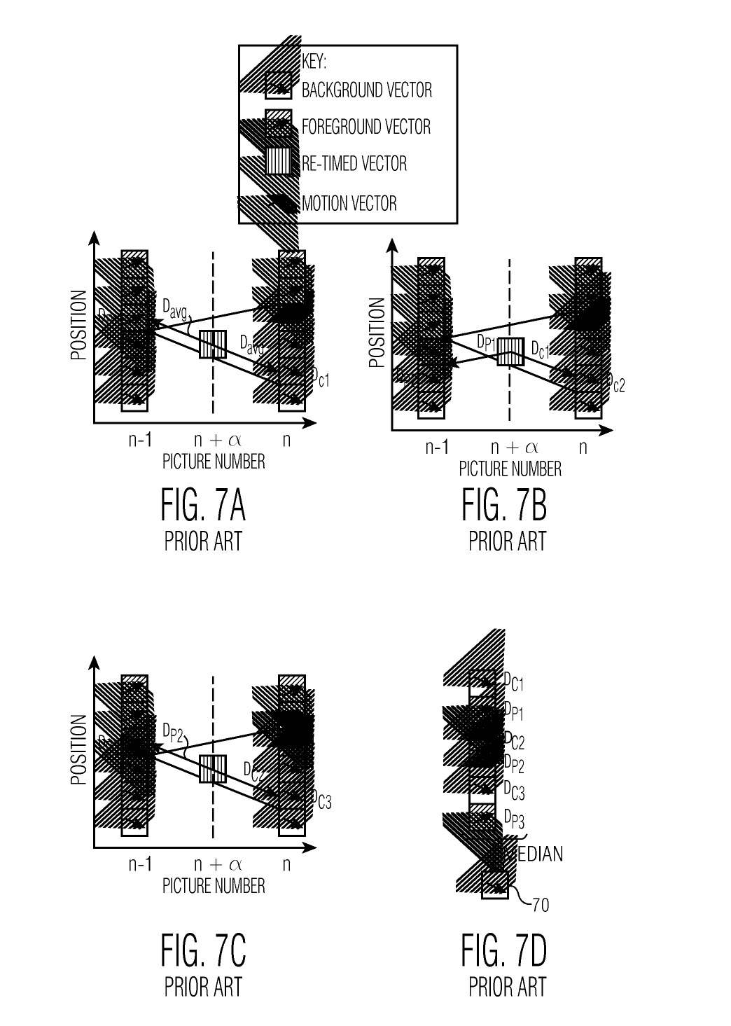

A re-timer is an important part of minimizing the halo problem. For halo-reduced up-conversion, an accurate vector field is needed at the interpolation position. The re-timer function is to take the output of the motion estimator and calculate a re-timed vector field. The starting point is the averaged vector (\vec{D}avg( )) as calculated in Equation 2.1. The averaged vector is used to find a vector in the previous three-frame vector field referred to as vector \vec{D}_{P1} (FIG. 7A). Then vector \vec{D}_{P1} is used to find another vector in the previous vector field called vector \vec{D}_{P2} (FIG. 7B). And, vector \vec{D}_{P2} is used to find vector \vec{D}_{P3} (FIG. 7C). The same is done in the current 3-frame vector field. With \vec{D}_{avg} as starting point three more vectors are recursively found called vectors \vec{D}_{C1}, \vec{D}_{C2} and \vec{D}_{C3} (FIGS. 7A, B and C). FIGS. 7A, B and C depict examples in an uncovering area. Since the algorithm is symmetrical, it also works the same way for covering. In the foreground object, the majority of the 6 vectors are foreground vectors, and in the occlusion area or background area the majority of the vectors are background vectors. A 6-tap median vector is used to select the wanted vector for the re-timed vector field 70 (FIG. 7D). Equation 2.2 shows how the 6 vectors are calculated. In Equation 2.3 \vec{D}ᵣ(\vec{B}, n+α) is the re-timed vector at spatial position \vec{B} and temporal position n+α.

\vec{D}_{P1}=\vec{D}₃\vec{B}−(α+1)\vec{D}_{avg}(\vec{B},n+α),n−1)

\vec{D}_{P2}=\vec{D}₃(\vec{B}−(α+1)\vec{D}_{P1},n−1)

\vec{D}_{P3}=\vec{D}₃\vec{B}−(α+1)\vec{D}_{P2},n−1)

\vec{D}_{C1}=\vec{D}₃\vec{B}+α\vec{D}_{avg}(\vec{B},n+α),n)

\vec{D}_{C2}=\vec{D}₃\vec{B}+α\vec{D}_{P1},n)

\vec{D}_{C3}=\vec{D}₃\vec{B}+α\vec{D}_{P2},n) (2.2)

\vec{D}ᵣ(\vec{B},n+α)=MEDIAN(\vec{D}_{P1},\vec{D}_{P2},\vec{D}_{P3},\vec{D}_{C1},\vec{D}_{C2},\vec{D}_{C3}) (2.3)

This previous algorithm and technique (Puma/Cobra: motion estimator and temporal up-converter) that determines a re-timed vector field that is needed for the interpolation position requires a minimum of seven calculations for each set of interpolation positions. Such calculations are time consuming, and taxing on a programmable platform that is calculating the vectors for the video processing algorithms. Such a technique is also expensive to successfully incorporate and implement in a programmable video platform. What is needed is a less complex algorithm that is less expensive to successfully implement in a programmable video platform.

In view of the afore mentioned difficulty to implement a temporal up-converter that calculates a median vector via a 6-tap median filter due to it being very expensive to implement as well as other disadvantages, not specifically mentioned above, it is apparent that there is a need an alternate implementation that is significantly less complex and provides at least the same or better performance. As a result, embodiments of the present invention provide a method to interpolate or extrapolate a motion vector field from two or more motion vector fields. A basic exemplary method comprises: First, selecting a number of candidate pairs (a pair can be more than two) of vectors from the different motion vector fields. A vector is used to fetch the vectors of the pair. Second, choose on pair based on an error metric. And third, apply linear or non-linear interpolation to obtain the required vector.

Other exemplary embodiments of the invention may include a method of performing motion compensated de-interlacing and film judder removal that comprises selecting a plurality of candidate vector pairs from different motion vector fields. Then choosing one of the plurality of candidate vector pairs based on an error metric. And, applying at least one of a linear and a non-linear interpolation to the chosen candidate vector pair to obtain a re-timing vector.

Still other embodiments of the invention may include a programmable platform that implements a video-processing algorithm. The video-processing algorithm includes a motion estimator algorithm and a temporal up-converter algorithm. The temporal up-converter algorithm comprises a re-timer algorithm. The re-timer algorithm selects a plurality of candidate vector pairs from different motion vector fields. The re-timer algorithm then chooses one of the plurality of candidate vector pairs based on an error metric. Then it applies linear or a non-linear interpolation to the chosen vector pair to obtain a re-timing vector.

It is understood that the above summary of the invention is not intended to represent each embodiment or every aspect of embodiments of the present invention.

A more complete understanding of the method and apparatus of the present invention may be obtained by reference to the following Detailed Description when taken in conjunction with the accompanying Drawings wherein:

FIG. 1 is an example of a moving ball displayed with motion judder;

FIG. 2 is an example of a moving ball displayed in an ideal fashion without motion judder;

FIG. 3 is depicts an occlusion problem when displaying two moving balls;

FIG. 4 is an example of motion estimation at a temporal position;

FIG. 5A is an example of a backward motion estimation;

FIG. 5B is an example of a forward motion estimation;

FIG. 6 is an example of combining vector fields from both a forward and backward motion estimation into an occlusion free vector field at the position of the original picture.

FIGS. 7A, B, C, and D are examples of a prior art re-timer function;

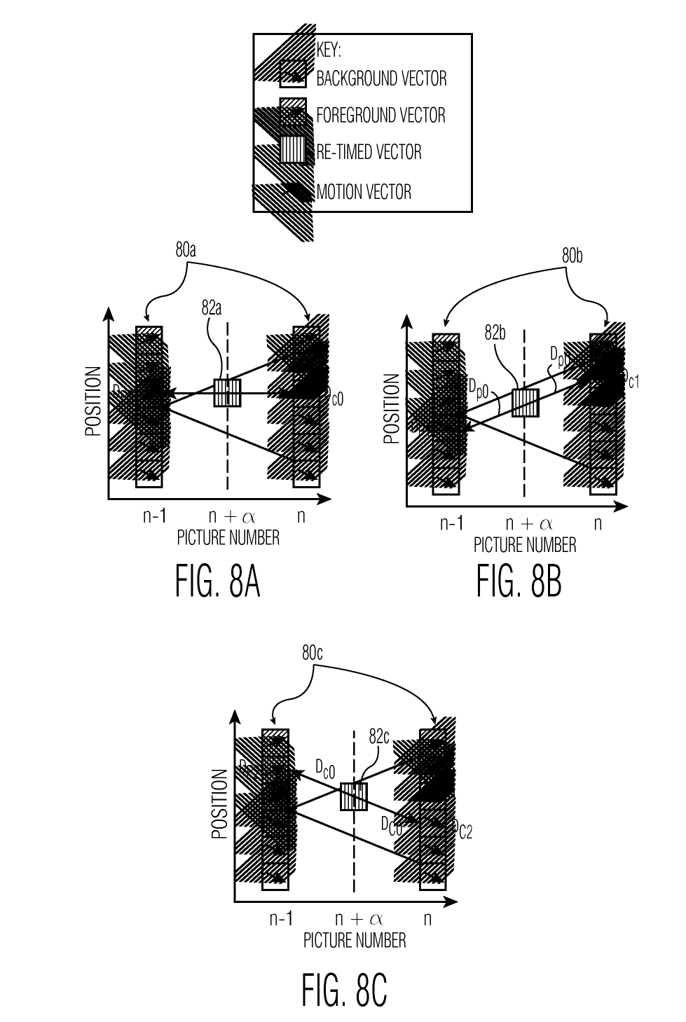

FIG. 8A is an example of an exemplary re-timer function selecting a non-motion compensated vector pair;

FIG. 8B is an example of an exemplary re-timer function selecting a vector pair from a previous vector field; and

FIG. 8C is an example of an exemplary re-timer function selecting a vector pair from a current vector field.

Programmable platforms are used more and more for the implementation of video processing algorithms. Some advantages of using programmable platforms are that the same design can be used for a wide range of products, that the time to market can be kept short, and the function can be altered or improved at a late design stage or even after production has begun.

Exemplary programmable platforms in accordance with embodiments of the invention are specially designed for media processing. The types of media that can be processed by exemplary programmable platforms include video processing that performs motion compensated de-interlacing and film judder removal (Natural Motion). Such exemplary programmable platforms may be capable of processing various video formats including, but not limited to MPEG1, MPEG2, MPEG3, MPEG4, High Definition Natural Motion, Standard Definition Natural Motion, and others. Currently there are several chips on the market for use with or on an exemplary programmable platform. Such chips include the Philips TriMedia processor cores TM-1, tm3260, tm3270, tm2270, and the tm5250. One of ordinary skill in the art would understand that other processor cores could also be used with or incorporated into an exemplary programmable platform and be able to perform an algorithm that is equivalent to embodiments of the present invention.

For additional clarity, the basic architecture of a TriMedia device will be briefly described. The TriMedia is a VLIW (Very Large Instruction Word) processor with five issue slots. Having five issue slots means that in every cycle five operations can be performed at once. All the operations are register based and both an instruction and a data cache are utilized. A compiler and scheduler analyze the code and determine which operations can be done simultaneously. For every issue slot, multiple functional units are available. Having multiple functional units available for every issue slot gives the scheduler a lot of freedom with respect to where an operation is scheduled. A TriMedia processor incorporates compile-time scheduling. The advantages of compile-time scheduling are that the chip size is smaller because the scheduler doesn't have to be on the chip and that a better scheduler can be utilized. A better scheduler is able to utilize a larger context and has more knowledge of the source code.

In some embodiments, all the communication from and to memory passes a data or instruction cache. The data cache is 128 Kb in size and is 4-way set associative. Getting data from the cache into the registers is done with a special functional unit, the load unit. There is one load unit that can do a variety of different things. For example, a normal load of up to 32 bit writes one register and, a super load can load two adjacent words of 32bit. Also, a load with on the fly linear interpolation is possible. Two store units are available to copy data from the register file into the data cache. If the CPU needs data that is not in the cache the data is requested from the memory and the CPU stalls until the data is available. To prevent the CPU from stalling to often, a hardware pre-fetch can be used to copy data from the main memory into the cache on the background.

Most operations have two input registers, one output register and a guard register. The result of an operation is only written back to the output register if the guard is true. This saves a lot of jumps. The TM3270 also has two-slot operations. These functional units use two neighboring issue slots and therefore up to four input registers and two output registers can be used. This enables the architecture to handle a much wider range of instructions, for example, median and mix operations.

The TriMedia works with data words of 32 bits. Yet, a lot of video and/or audio data is found in 8 or 16 bit variables or word. In order to handle the 8 or 16 bit variables a SIMD (Single Instruction Multiple Data) instructions set is implemented. In a SIMD instruction four 8 bit or two 16 bit instructions are provided in one instruction. For instance the QUADAVG instruction calculates four different averages. These SIMD instructions can be used to speed up the code.

A TriMedia core, or other operable processor core, is usually part of a bigger SoC (System on Chip). A SoC chip can contain multiple cores, video co-processors like scalers, video and audio IO, etc. All the communication with the peripherals goes through memory.

One of the goals for some of the embodiments of the present invention is to map a reduced halo temporal up-converter on a processor core. A starting point for an exemplary algorithm is to be an improvement over the Cobra temporal up-converter algorithm explained above. The resulting picture quality of some of the exemplary embodiments should be similar or better than that produced by the prior Cobra temporal up-converter algorithm. Work has been done for the motion estimator portion of the algorithms, but that work is outside the scope of this invention. As such, the motion estimator used in exemplary embodiments of the present invention can be similar to the puma estimator explained above. It is further understood that one of ordinary skill in the art would understand that other motion estimator algorithms could also be used with embodiments of the present invention.

Embodiments of an exemplary temporal up-converter will now be explained. Experimentation and modeling were used to support the algorithmic choices in the exemplary embodiments. Resulting picture quality evaluations ultimately supported the selection of the algorithmic choices. An exemplary up-converter is divided into separate blocks. The separate blocks include an advanced implementation the re-timer, occlusion detector, and inconsistency meter are integrated in the vector processing. A vector split function is integrated with the pixel processing. But, for understanding the algorithm it is best to see each block as a separate block. An exemplary algorithm was developed with the Philips TM3270 in mind. One large advantage of using a programmable platform in embodiments of the invention is the possibility of incorporating load balancing into the system. Another advantage is that the same resources can be used for different things. Thus, in embodiments of the exemplary invention it is possible that for every block of output pixels, the best available algorithm that fits within the cycle budget can be used to process the vector data.

The main problem with the prior art Cobra re-timer, discussed above, is that it requires a 6-tap median, which is complex and too expensive to implement. Embodiments of the invention provide a new solution for the re-timer that is much less expensive to implement. And, provides equal or better picture quality.

Referring now to FIGS. 8A, 8B and 8C, an exemplary re-timer uses two vector fields of time (80a, 80b, and 80c). The vector field's times are at, for example, n and n−1 picture numbers and came from the 3-frame motion estimator. In between the n and n−1 picture numbers is the n+α(−1<α<0), which is the re-timed vector field (82a, 82b, or 82c) that has to be calculated.

The starting point is a vector field from a 3-frame estimator, \vec{D}₃(\vec{x},n). This 3-frame motion vector field is estimated between luminance frames F(\vec{x},n−1), F(\vec{x},n) and F(\vec{x},n +1). The basic concept is that for every re-timed vector (82a, 82b, or 82c) a couple (or a plurality of) candidate vector pairs (82a, 82b, and 82c) are evaluated (Also, a pair can be more than two vectors from the different motion vector fields.) In this exemplary implementation three vector pairs are evaluated. The first vector pair are non-motion compensated vectors fetched from the previous and current vector field (n−1, n) 80a (FIG. 8A and Equation 4.1). The other vector two pairs (82b and 82c) are the result of motion compensated fetches in the two vector fields using the two vectors from the first pair (FIG. 8B, 8C and Equation 4.2 and 4.3). A motion compensated fetch means that a vector is used to determine the position in the vector field. In embodiments of the invention, a vector is quanitized because of the block size.

\vec{D}_{PO}=\vec{D}₃(\vec{B},n−1)

\vec{D}_{C0}=\vec{D}₃(\vec{B},n) (4.1)

\vec{D}_{P1}=\vec{D}₃(B−(α+1)\vec{D}_{P0},n−1)

\vec{D}_{C1}=\vec{D}₃(\vec{B}−α\vec{D},n) (4.2)

\vec{D}_{P2}=\vec{D}₃(B−(α+1)\vec{D}_{C0},n−1)

\vec{D}_{C2}=\vec{D}₃(\vec{B}−αD_{C0},n) (4.3)

From these three candidate vector pairs (82a, 82b, and 82c), the vector pair with the lowest error is selected. Various error metrics can be used. One exemplary error metric is defined by:

diƒₖ=(D_{Ck}^{x}−D_{Pk}^{x})²+(D_{Ck}^{y}−D_{Pk}^{y})²∀kε{0,1,2} (4.4)

A linear or non-linear interpolation can be applied to the two vectors with the lowest error in order to obtain the required re-timed vector. In this exemplary embodiment, the re-timed vector is the average of the two vectors in the pair with the lowest error:

\vec{D}ᵣ(\vec{B},n+α)=Average(\vec{D}_{Ck}+\vec{D}_{Pk}) {k|diƒₖ<diƒᵢ∀iε{0,1,2}} (4.5)

This re-timing vector calculation is done for every position in the interpolated vector field. It is not always necessary to use the same number of vector pairs or the same number vectors in a pair (a pair can be two or more vectors) everywhere in the vector field. The re-timed vector is used at the interpolation position for a (halo-reduced) temporal up-conversion. The average of two vectors, rather than a median of 6 vectors, is relatively inexpensive to implement in an exemplary programmable platform. Embodiments of the invention thus provide a system and method to interpolate or extrapolate a motion vector field from other (two or more) motion vector fields. To summarize the basic exemplary method, first, a number of candidate vector pairs (82a, 82b, 82c) (a pair can be two or more) are selected from the different motion vector fields (80a, 80b, 80c). A vector is used to fetch the vectors of the pair. Second, one of the vector pairs is chosen based on an error metric. Third and finally, a linear or non-linear interpolation is applied to the chosen vector pair to obtain the needed vector that will decrease or reduce the amount of halo and or judder present in a resulting displayed moving image or images.

Typical uses for embodiments of the present invention are in a temporal up-converter for a video-processing device that performs motion compensated film judder removal (e.g. Natural Motion). Such video processing devices or platforms that use embodiments of the present invention may be directed to halo reduction. As such, typical products in which the invention can be used are TV sets, DVD players, TV Set-top boxes, MPEG players, digital or analog video recorders or players, and portable video devices.

Many variations and embodiments of the above-described invention and method are possible. Although only certain embodiments of the invention and method have been illustrated in the accompanying drawings and described in the foregoing Detailed Description, it will be understood that the invention is not limited to the embodiments disclosed, but is capable of additional rearrangements, modifications and substitutions without departing from the invention as set forth and defined by the following claims. Accordingly, it should be understood that the scope of the present invention encompasses all such arrangements and is solely limited by the claims as follows:

1. A method of performing motion compensated video processing comprising:
selecting a plurality of candidate vector pairs from different motion vector fields;
choosing one of said plurality of candidate vector pairs based on an error metric; and
applying at least one of a linear and non-linear interpolation to said one chosen candidate vector pair to obtain a re-timing vector for halo reduced up-conversion.

2. The method of claim 1, further comprising using said re-timing vector for at least one of temporal up-conversion, frame rate conversion, film judder removal, and temporal filtering of a vector field.

3. The method of claim 1, wherein said plurality of candidate vector pairs are from non-motion compensated vectors fetched from a previous vector field and a present vector field and a result of motion compensated vector fetches from said previous and said present vector fields using the two vectors from the pair of vectors.

4. The method of claim 1, wherein said applying comprises averaging said one chosen vector pair to obtain said re-timing vector.

5. The method of claim 1, wherein the selecting, choosing and applying is performed for every position in an interpolated vector field.

6. The method of claim 1, wherein said choosing is performed by selecting the candidate vector pair with a lowest calculated error.

7. A programmable platform that implements a video processing algorithm, said video processing algorithm comprises:
a motion estimator algorithm; and
a temporal up-converter algorithm, said temporal up-converter algorithm comprises a re-timer algorithm, said re-timer algorithm selects a plurality of candidate vector pairs from different motion vector fields; then chooses one of said plurality of candidate vector pairs based on an error metric; and applies at least one of a linear and non-linear interpolation to said one chosen candidate vector pair to obtain a re-timing vector used for halo reduced up-conversion.

8. The programmable platform of claim 7, wherein said plurality of candidate vector pairs are from non-motion compensated vectors fetched from a previous vector field and a present vector field and a result of motion compensated vector fetches from said previous and said present vector fields using the two vectors from the pair of vectors.

9. The programmable platform of claim 7, wherein said error metric determines which one of said plurality of candidate vector pairs has a lowest amount of error.

10. A method of reducing halo in a video up-conversion process, said method comprising:
performing a motion estimator algorithm;
performing a temporal up-converter algorithm; and
performing a re-timer algorithm that provides a re-timer vector for halo reduced up-conversion.

11. The method of claim 10, wherein said re-timer algorithm comprises:
selecting a plurality of candidate vector pairs from different motion vector fields;
choosing one of said plurality of candidate vector pairs based on an error metric; and
applying at least one of a linear and non-linear interpolation to said one chosen candidate vector pair to obtain a re-timing vector for halo reduced up conversion.
